(19) United States
(12) Patent Application Publication
(10) Pub. No.: US 2021/0179115 A1
(43) Pub. Date: Jun. 17, 2021

(54) METHOD AND APPARATUS FOR MONITORING A YAW SENSOR

(71) Applicant: GM GLOBAL TECHNOLOGY OPERATIONS LLC, Detroit, MI (US)

(72) Inventors: Jagannadha Reddy Satti, Walled Lake, MI (US); Xiaofeng F. Song, Novi, MI (US); Shuqing Zeng, Sterling Heights, MI (US); Abdoul Karim Abdoul Azizou, Oshawa (CA); Azadeh Farazandeh, Thornhill (CA)

(73) Assignee: GM GLOBAL TECHNOLOGY OPERATIONS LLC, Detroit, MI (US)

(21) Appl. No.: 16/715,545

(22) Filed: Dec. 16, 2019

(51) Int. Cl. B60W 40/114; G01S 19/39

(52) U.S. Cl. CPC B60W 40/114; G01S 19/393; B60W 2520/14; B60W 2420/52; B60W 2556/50; B60W 2556/60; B60W 2420/42; B60W 2520/06

(57) ABSTRACT

A method and associated system for monitoring the on-vehicle yaw-rate sensor includes determining a vehicle heading during vehicle operation and determining a first vehicle heading parameter based thereon. A second vehicle heading parameter is determined via the yaw-rate sensor. A yaw-rate sensor bias parameter is determined based upon the first vehicle heading parameter and the second vehicle heading parameter. A first yaw term is determined via the yaw-rate sensor, and a final yaw term is determined based upon the first yaw term and the yaw-rate sensor bias parameter.

### INTRODUCTION

Vehicle chassis stability control systems and on-vehicle driver assistance systems, such as advanced driver assistance systems (ADAS), employ information from yaw-rate sensors to monitor vehicle angular velocity relative to a vertical axis. Such information is useful for providing autonomous operation, including, e.g., adaptive cruise control systems, lane keeping assistance systems, and lane change assistance systems. Such information is also useful for advanced vehicle stability control.

A signal output from a yaw-rate sensor may be subject to drift, which can affect performance of lane keeping assistance systems, lane change assistance systems, and chassis stability control systems. Known systems for monitoring a yaw-rate sensor require vehicle operation in a straight line or in a stopped condition with steering wheel angle at or near zero degrees of rotation. This may lead to having only a limited time window for monitoring, such that sensor bias may not be determined over multiple key cycles. Sensor bias may be susceptible to environmental factors such as ambient temperature. Furthermore, sensor bias may be due to sensor aging. As such, there is a need to provide an improved system and associated method for monitoring a yaw-rate sensor to detect sensor drift, compensate for sensor drift, and indicate a fault associated with sensor drift.

### SUMMARY

A vehicle that includes a yaw-rate sensor for operational control of either or both an advanced driver assistance system (ADAS) and a chassis stability control system is described. In one embodiment, the advanced driver assistance system (ADAS) may employ input from the yaw-rate sensor to execute a lane-keeping routine or an automatic lane change assistance (ALC) maneuver, such as a lane change on demand ALC maneuver.

A method and associated system for monitoring the on-vehicle yaw-rate sensor includes determining a vehicle heading during vehicle operation and determining a first vehicle heading parameter based thereon. A second vehicle heading parameter is determined via the yaw-rate sensor. A yaw-rate sensor bias parameter is determined based upon the first vehicle heading parameter and the second vehicle heading parameter. A first yaw term is determined via the yaw-rate sensor, and a final yaw term is determined based upon the first yaw term and the yaw-rate sensor bias parameter.

An aspect of the disclosure includes determining the vehicle heading by monitoring input from a global navigation satellite system (GNSS) sensor to determine the vehicle heading.

Another aspect of the disclosure includes determining the vehicle heading by determining, via a GNSS sensor, a map heading parameter, determining, via a camera, a camera heading parameter, and determining, via a third sensor, a third heading parameter. Respective first, second, and third weighting factors are determined for the respective map heading parameter, camera heading parameter, and third heading parameter, and the first vehicle heading parameter is determined based upon the map heading parameter, the camera heading parameter, the third heading parameter, and the respective first, second, and third weighting factors.

Another aspect of the disclosure includes the third sensor being a surround-view camera, and wherein determining, via the third sensor, the third heading parameter comprises determining the third heading parameter based upon the surround-view camera.

Another aspect of the disclosure includes the third sensor being a lidar device, and wherein determining, via the third sensor, the third heading parameter comprises determining the third heading parameter based upon the lidar device.

Another aspect of the disclosure includes the first, second, and third weighting factors for the respective map heading parameter, camera heading parameter, and third heading parameter being dynamically determined based upon expected reliabilities of the vehicle heading information from the GNSS sensor, the camera, and the third sensor.

Another aspect of the disclosure includes detecting a fault associated with the yaw-rate sensor when the yaw-rate sensor bias parameter is greater than a threshold.

Another aspect of the disclosure includes controlling operation of the vehicle based upon the final yaw term.

Another aspect of the disclosure includes determining a first vehicle heading change rate based upon the first vehicle heading parameter.

Another aspect of the disclosure includes determining, via the yaw-rate sensor, the second vehicle heading parameter by determining a second vehicle heading change rate based upon the second vehicle heading parameter.

Another aspect of the disclosure includes periodically determining the first vehicle heading parameter and the second vehicle heading parameter, and periodically determining a bias parameter based upon the periodically determined first vehicle heading parameter and second vehicle heading parameter. Determining the yaw-rate sensor bias parameter based upon the first vehicle heading parameter and the second vehicle heading parameter includes determining a mean value for the periodically determined bias parameter.

Another aspect of the disclosure includes determining the vehicle heading during vehicle operation by determining the vehicle heading during dynamic vehicle operation that includes operation on a curved roadway.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a side-view of a vehicle including a yaw-rate sensor, wherein the vehicle is configured with an advanced driver assistance system (ADAS), in accordance with the disclosure.

FIG. 2 schematically illustrates a diagram associated with a yaw rate bias estimator to dynamically monitor vehicle operation to determine a yaw rate bias term associated with an on-vehicle yaw-rate sensor, in accordance with the disclosure.

FIG. 3 schematically illustrates a diagram that illustrates information flow effect sensor fusion to dynamically monitor an on-vehicle yaw-rate sensor, in accordance with the disclosure.

FIG. 4 pictorially illustrates parameters associated with a vehicle traveling on a roadway and related to a yaw rate bias estimator, in accordance with the disclosure.

FIG. 5 schematically illustrates a process, in flowchart form, for dynamically monitoring an on-vehicle yaw-rate sensor, in accordance with the disclosure.

The appended drawings are not necessarily to scale, and present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure.

The drawings are in simplified form and are not to precise scale. For purposes of convenience and clarity, directional terms such as longitudinal, lateral, top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

As used herein, the term “system” refers to mechanical and electrical hardware, software, firmware, electronic control components, processing logic, and/or processor devices, individually or in combination, that provide the described functionality. This may include, without limitation, an application specific integrated circuit (ASIC), an electronic circuit, a processor (shared, dedicated, or group) that executes one or more software or firmware programs, memory to contain software or firmware instructions, a combinational logic circuit, and/or other components.

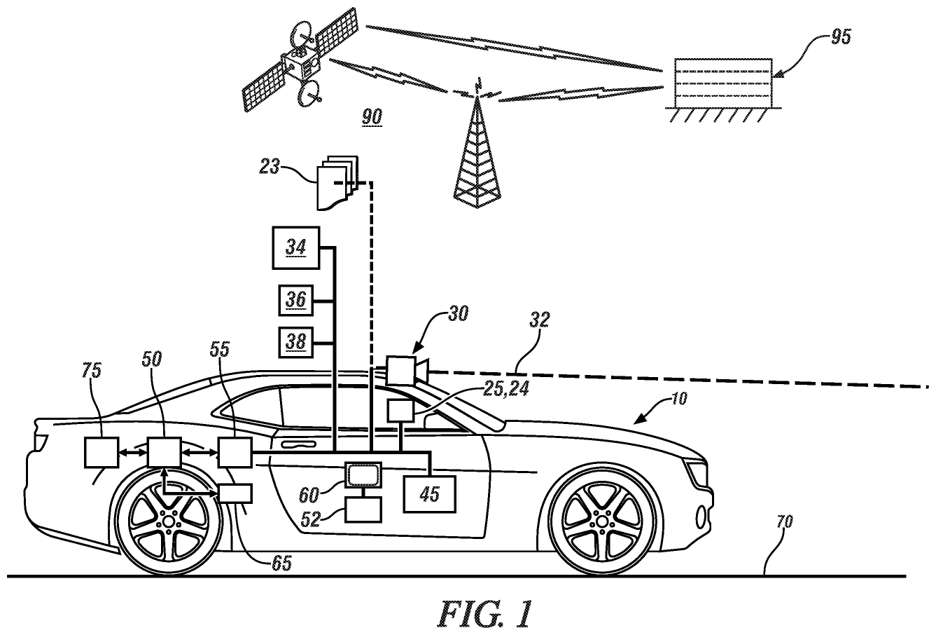

Referring to the drawings, wherein like reference numerals correspond to like or similar components throughout the several Figures, FIG. 1, consistent with embodiments disclosed herein, schematically illustrates a side-view of a vehicle 10 that is disposed on and able to traverse a travel surface 70 such as a paved road surface. The vehicle 10 includes a yaw-rate sensor 45, an on-board navigation system 24, a computer-readable storage device or media (memory) 23 that includes a digitized roadway map 25, a spatial monitoring system 30, a vehicle controller 50, a global navigation satellite system (GNSS) sensor 52, a human/machine interface (HMI) device 60, and in one embodiment an autonomous controller 65 and a telematics controller 75. The vehicle 10 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

The yaw-rate sensor 45 is an inertia-based sensor in one embodiment in the form of a gyroscopic device that employs a piezoelectric accelerometer that dynamically monitors angular velocity of the vehicle 10 around a vertical axis. The yaw-rate sensor 45 generates an output signal that is monitored by the vehicle controller 50 or another on-board controller.

The spatial monitoring system 30 includes one or a plurality of spatial sensors and systems that are arranged to monitor a viewable region 32 that is forward of the vehicle 10, and a spatial monitoring controller 55. The spatial sensors that are arranged to monitor the viewable region 32 forward of the vehicle 10 include, e.g., a lidar sensor 34, a surround-view camera 36, a forward-view camera 38, etc. A radar sensor (not shown) may also be employed as a spatial sensor.

Each of the spatial sensors is disposed on-vehicle to monitor all or a portion of the viewable region 32 to detect proximate remote objects such as road features, lane markers, buildings, pedestrians, road signs, traffic control lights and signs, other vehicles, and geographic features that are proximal to the vehicle 10. The spatial monitoring controller 55 generates digital representations of the viewable region 32 based upon data inputs from the spatial sensors. The spatial monitoring controller 55 can evaluate inputs from the spatial sensors to determine a linear range, relative speed, and trajectory of the vehicle 10 in view of each proximate remote object. The spatial sensors can be located at various locations on the vehicle 10, including the front corners, rear corners, rear sides and mid-sides. The spatial sensors can include a front radar sensor and a camera in one embodiment, although the disclosure is not so limited. Placement of the spatial sensors permits the spatial monitoring controller 55 to monitor traffic flow including proximate vehicles, intersections, lane markers, and other objects around the vehicle 10. Data generated by the spatial monitoring controller 55 may be employed by a lane marker detection processor (not shown) to estimate the roadway.

The lidar sensor 34 employs a pulsed and reflected laser beam to measure range or distance to an object. The surround-view camera 36 includes an image sensor and lens, communicates with a video processing module (VPM), and operates to monitor a 360° viewable region that surrounds the vehicle 10. The forward-view camera 38 includes an image sensor, lens, and a camera controller. The image sensor is an electro-optical device that converts an optical image into an electronic signal employing a multi-dimensional array of light-sensitive sensing elements. The camera controller is operatively connected to the image sensor to monitor the viewable region 32. The camera controller is arranged to control the image sensor to capture an image of a field of view (FOV) that is associated with the viewable region 32 that is projected onto the image sensor via the lens. The optical lens may be configured to include features such as a pin-hole lens, a fisheye lens, a stereo lens, a telescopic lens, etc. The forward-view camera 38 periodically captures, via the image sensor, an image file associated with the viewable region 32 at a desired rate, e.g., 30 image files per second. Each image file is composed as a 2D or 3D pixelated digital representation of all or a portion of the viewable region 32 that is captured at an original resolution of the forward-view camera 38. In one embodiment, the image file is in the form of a 24-bit image including RGB (red-green-blue) visible light spectrum values and depth values that represent the viewable region 32. Other embodiments of the image file can include either a 2D or 3D image at some level of resolution depicting a black-and-white or a grayscale visible light spectrum representation of the viewable region 32, an infrared spectrum representation of the viewable region 32, or other image representations without limitation. The image representations of the plurality of image files can be evaluated for parameters related to brightness and/or luminance in one embodiment. Alternatively, the image representations may be evaluated based upon RGB color components, brightness, texture, contour, or combinations thereof. The image sensor communicates with an encoder, which executes digital signal processing (DSP) on each image file. The image sensor of the forward-view camera 38 may be configured to capture the image at a nominally standard-definition resolution, e.g., 640×480 pixels. Alternatively, the image sensor of the forward-view camera 38 may be configured to capture the image at a nominally high-definition resolution, e.g., 1440×1024 pixels, or at another suitable resolution. The image sensor of the forward-view camera 38 may capture still images, or alternatively, digital video images at a predetermined rate of image capture. The image files are communicated to the camera controller as encoded datafiles that are stored in a non-transitory digital data storage medium in one embodiment for on-board or off-board analysis.

The forward-view camera 38 is advantageously mounted and positioned on the vehicle 10 in a location that permits capturing images of the viewable region 32, wherein at least a portion of the viewable region 32 includes a portion of the travel surface 70 that is forward of the vehicle 10 and includes a trajectory of the vehicle 10. The viewable region 32 may also include a surrounding environment, including, e.g., vehicle traffic, roadside objects, pedestrians, and other features, the sky, a horizon, the lane of travel and on-coming traffic forward of the vehicle 10. Other cameras (not shown) may also be employed, including, e.g., a second camera that is disposed on a rear portion or a side portion of the vehicle 10 to monitor rearward of the vehicle 10 and one of the right or left sides of the vehicle 10.

The autonomous controller 65 is configured to implement autonomous driving or advanced driver assistance system (ADAS) vehicle functionalities. Such functionality may include an on-vehicle control system that is capable of providing a level of driving automation. The terms ‘driver’ and ‘operator’ describe the person responsible for directing operation of the vehicle 10, whether actively involved in controlling one or more vehicle functions or directing autonomous vehicle operation. Driving automation can include a range of dynamic driving and vehicle operation. Driving automation can include some level of automatic control or intervention related to a single vehicle function, such as steering, acceleration, and/or braking, with the driver continuously having overall control of the vehicle 10. Driving automation can include some level of automatic control or intervention related to simultaneous control of multiple vehicle functions, such as steering, acceleration, and/or braking, with the driver continuously having overall control of the vehicle 10. Driving automation can include simultaneous automatic control of vehicle driving functions that include steering, acceleration, and braking, wherein the driver cedes control of the vehicle for a period of time during a trip. Driving automation can include simultaneous automatic control of vehicle driving functions, including steering, acceleration, and braking, wherein the driver cedes control of the vehicle 10 for an entire trip. Driving automation includes hardware and controllers configured to monitor the spatial environment under various driving modes to perform various driving tasks during dynamic vehicle operation. Driving automation can include, by way of non-limiting examples, cruise control, adaptive cruise control, lane-change warning, intervention and control, automatic parking, acceleration, braking, and the like. The autonomous vehicle functions include, by way of non-limiting examples, an adaptive cruise control (ACC) operation, lane guidance and lane keeping operation, lane change operation, steering assist operation, object avoidance operation, parking assistance operation, vehicle braking operation, vehicle speed and acceleration operation, vehicle lateral motion operation, e.g., as part of the lane guidance, lane keeping and lane change operations, etc. As such, the braking command can be generated by the autonomous controller 65 independently from an action by the vehicle operator and in response to an autonomous control function.

Operator controls may be included in the passenger compartment of the vehicle 10 and may include, by way of non-limiting examples, a steering wheel, an accelerator pedal, the brake pedal and an operator input device that is an element of the HMI device 60. The operator controls enable a vehicle operator to interact with and direct operation of the vehicle 10 in functioning to provide passenger transportation. The operator control devices including the steering wheel, accelerator pedal, brake pedal, transmission range selector and the like may be omitted in some embodiments of the vehicle 10.

The HMI device 60 provides for human/machine interaction, for purposes of directing operation of an infotainment system, the GNSS sensor 52, the navigation system 24 and the like, and includes a controller. The HMI device 60 monitors operator requests and provides information to the operator including status of vehicle systems, service and maintenance information. The GNSS sensor 52 is an element of a satellite navigation system that is capable of providing autonomous geo-spatial positioning with global coverage to determine location in the form of longitude, latitude, and altitude/elevation using time signals transmitted along a line of sight by radio from satellites. One embodiment of the GNSS sensor is a global positioning system (GPS) sensor.

The HMI device 60 communicates with and/or controls operation of a plurality of operator interface devices, wherein the operator interface devices are capable of transmitting a message associated with operation of one of the autonomic vehicle control systems. The HMI device 60 may also communicate with one or more devices that monitor biometric data associated with the vehicle operator, including, e.g., eye gaze location, posture, and head position tracking, among others. The HMI device 60 is depicted as a unitary device for ease of description, but may be configured as a plurality of controllers and associated sensing devices in an embodiment of the system described herein. Operator interface devices can include devices that are capable of transmitting a message urging operator action, and can include an electronic visual display module, e.g., a liquid crystal display (LCD) device, a heads-up display (HUD), an audio feedback device, a wearable device and a haptic seat. The operator interface devices that are capable of urging operator action are preferably controlled by or through the HMI device 60. The HUD may project information that is reflected onto an interior side of a windshield of the vehicle, in the field-of-view of the operator, including transmitting a confidence level associated with operating one of the autonomic vehicle control systems. The HUD may also provide augmented reality information, such as lane location, vehicle path, directional and/or navigational information, and the like.

The on-board navigation system 24 employs the digitized roadway map 25 for purposes of providing navigational support and information to a vehicle operator. The autonomous controller 65 employs the digitized roadway map 25 for purposes of controlling autonomous vehicle operation or ADAS vehicle functions.

The vehicle 10 may include a telematics controller 75, which includes a wireless telematics communication system capable of extra-vehicle communications, including communicating with a communication network 90 having wireless and wired communication capabilities. The telematics controller 75 is capable of extra-vehicle communications that includes short-range vehicle-to-vehicle (V2V) communication and/or vehicle-to-everything (V2x) communication, which may include communication with an infrastructure monitor, e.g., a traffic camera. Alternatively or in addition, the telematics controller 75 has a wireless telematics communication system capable of short-range wireless communication to a handheld device, e.g., a cell phone, a satellite phone or another telephonic device. In one embodiment the handheld device includes a software application that includes a wireless protocol to communicate with the telematics controller 75, and the handheld device executes the extra-vehicle communication, including communicating with an off-board server 95 via the communication network 90. Alternatively or in addition, the telematics controller 75 executes the extra-vehicle communication directly by communicating with the off-board server 95 via the communication network 90.

The term “controller” and related terms such as microcontroller, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.), which are indicated by memory 23. The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link or another suitable communication link. Communication includes exchanging data signals in suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium. A parameter is defined as a measurable quantity that represents a physical property of a device or other element that is discernible using one or more sensors and/or a physical model. A parameter can have a discrete value, e.g., either “1” or “0”, or can be infinitely variable in value.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

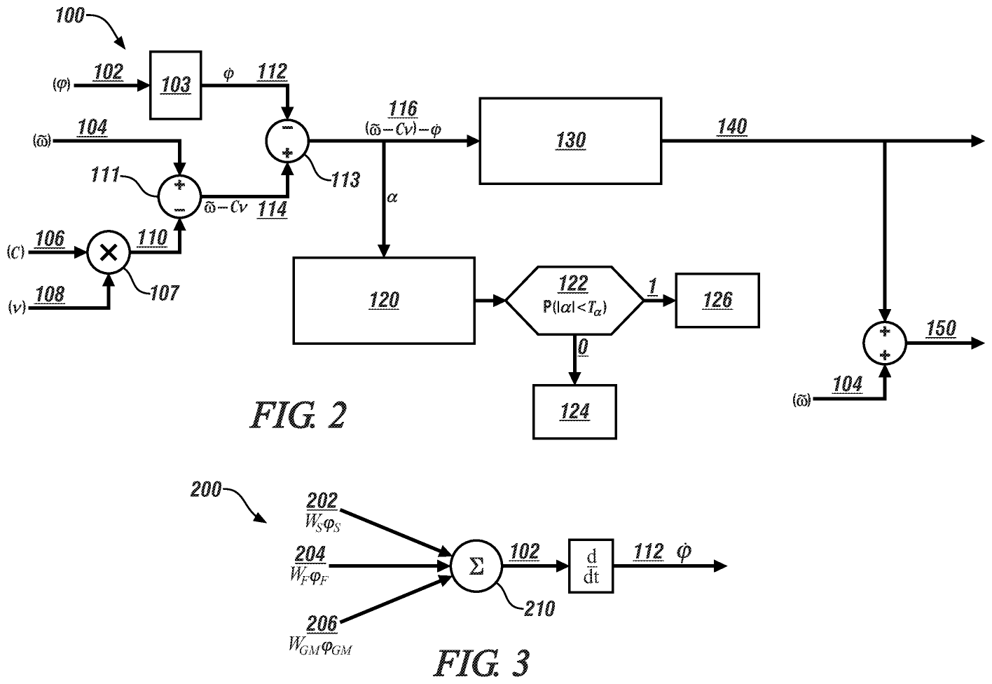

As described with reference to FIGS. 2, 3, 4 and 5, and with continued reference to the vehicle 10 that is described with reference to FIG. 1, monitoring of the yaw-rate sensor 45 includes dynamically monitoring inputs from other on-board sensing systems such as the forward-view camera 38, the surround-view camera 36, the lidar sensor 34, the GNSS sensor 52 and associated navigation map 25 to determine a vehicle heading while the vehicle 10 is in motion under a variety of operating conditions, including operation in a straight line and on curves, under acceleration or deceleration, and at idle/stop conditions. A first vehicle heading parameter is determined based upon the monitoring of the vehicle heading with the inputs from the other on-board sensing systems. A second vehicle heading parameter is determined by monitor inputs from the yaw-rate sensor 45. A yaw-rate sensor bias parameter is determined based upon the first vehicle heading parameter and the second vehicle heading parameter. A first yaw term is determined from the yaw-rate sensor 45, and a final yaw term is determined based upon the first yaw term and the yaw-rate sensor bias parameter.

FIG. 2 schematically shows a diagram associated with a yaw rate bias estimator 100, which illustrates information flow to dynamically monitor vehicle operation to determine a yaw rate bias term associated with a yaw-rate sensor, wherein an embodiment of the vehicle 10 including the yaw-rate sensor 45 is described with reference to FIG. 1.

Inputs to the yaw rate bias estimator 100 include vehicle heading (φ) 102, which indicates the vehicle heading with regard to its travel lane, observed yaw rate (\tilde{ω}) 104, lane curvature (C) 106, and vehicle speed (ν) 108.

A first vehicle heading parameter 112 is determined by monitoring the vehicle heading employing on-vehicle sensing systems other than the yaw-rate sensor 45. The first vehicle heading parameter 112 is considered to accurately capture a ground truth related to the vehicle heading. In one embodiment, the first vehicle heading parameter 112 is in the form of a first vehicle heading change rate \dot{φ}. The first vehicle heading parameter 112 is determined by determining the vehicle heading (φ) 102 by dynamically monitoring inputs from other on-board sensing systems such as one or more of the forward-view camera 38, the surround-view camera 36, the lidar sensor 34, and the GNSS sensor 52 and associated navigation map 25 and determining a time-rate change (103) thereof to determine the vehicle heading change rate \dot{φ}. The vehicle heading change rate (\dot{φ}) is useful in estimating signal bias in the yaw-rate sensor 45.

In one embodiment, vehicle heading (φ) 102 may be determined by monitoring inputs from multiple sensing systems and executing a sensor fusion routine 200. FIG. 3 schematically shows elements related to the sensor fusion routine 200, which determines the vehicle heading (φ) 102 based upon a weighted compilation of vehicle heading information from multiple independent sources of the vehicle heading information. In one embodiment, and as shown, there may be three or more independent sources of vehicle heading information, including information from the surround-view camera 36 and associated video processing module (VPM), information from the forward-view camera 38, and information from the GNSS sensor 52 and associated digital map 25. Alternatively or in addition to the surround-view camera 36, the lidar sensor 34 may be employed as a source of the vehicle heading information.

The VPM yields a VPM heading estimation (φ_{S}), the forward view camera yields a camera heading (φ_{F}), the GNSS yields a GNSS heading (φ_{GPS}), and the digital map yields a map heading (φ_{MAP}). A ground heading (φ_{GM}) is defined as a difference between the GNSS heading, i.e., (φ_{GM}=φ_{GPS}−φ_{MAP}). Respective weighting factors VPM heading factor w_{S}, forward view camera factor w_{F}, and ground heading factor w_{GM} can be determined, wherein the weighting factors are dynamically determined based upon expected reliabilities of the vehicle heading information from independent sources in the form of the GNSS sensor 52, the forward-view camera 38, the surround-view camera 36 and/or the lidar sensor 34. The expected reliabilities of the vehicle heading information from the independent sources may be based upon ambient and dynamic operating conditions related to lighting, ambient light, road conditions, precipitation, etc. By way of example, the camera heading estimation (φ_{F}) may be deemed most reliable, and thus accorded a high value for a weighting factor w_{F} when the vehicle is traveling during daylight hours on a roadway having a high density of roadway markers.

The vehicle heading (φ) 102 is determined by summing (210) the VPM heading estimation (φ_{S}), the camera heading (φ_{F}), and the ground heading (φ_{GM}), each which is multiplied by the respective weighting factor w_{S}, w_{F}, w_{GM}. The first vehicle heading change rate \dot{φ} 112 is determined by monitoring a time-rate change in the vehicle heading (φ) 102.

Referring again to FIG. 2, a second vehicle heading parameter 114 is determined, and is in the form of a vehicle heading change rate \dot{φ} that is determined based upon the observed yaw rate ( [symbol] 104 from the yaw-rate sensor 45, the lane curvature (C) 106, and the vehicle speed (ν) 108. This includes multiplying (107) the lane curvature (C) 106, and the vehicle speed (ν) 108, and subtracting (111) the resultant 110 from the observed yaw rate ( [symbol] 104 to determine the second vehicle heading parameter 114, which is referred to a second vehicle heading change rate that is expressed as \tilde{ω}−Cν. A bias angle α 116 between the first and second vehicle heading parameters 112, 114 is determined (113), and is expressed as (\tilde{ω}−Cν)−\dot{φ}.

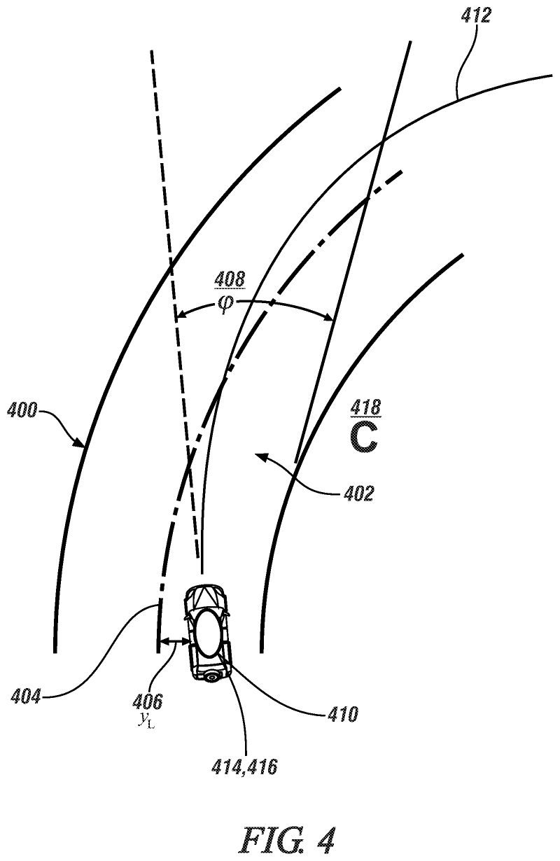

FIG. 4 pictorially illustrates parameters associated with a vehicle 410 that is traveling on a road surface 400, wherein the parameters are associated with a system dynamic equation and associated sensor noise model. The parameters may be used for evaluating information from the yaw-rate sensor 45 to separate sensor signal information, sensor bias, and sensor noise. As shown, the vehicle 410 is traveling on a travel lane 402 of the road surface 400 having a lane centerline 404. Parameters of interest include:

y_{L}, which is a lateral offset from lane centerline 406,

φ, which is a vehicle heading with respect to lane 408,

s, which is an arc length (or odometer) 412,

ν, which is vehicle longitudinal velocity 414,

ω, which is vehicle angular velocity 416, and

C, which is curvature 418 of the travel lane 402, and may be estimated from the vision and digital map data.

A noise model for an embodiment of the yaw-rate sensor 45 can be represented by EQ. 1, as follows:

\tilde{ω}=ω+b+n [1]

wherein
\tilde{ω} represents the observed yaw rate;
ω represents vehicle angular velocity;
b represents sensor bias; and
n represents a zero-mean, Gaussian white noise.

Governing equations include as follows:

\dot{φ}=ω−Cν

\dot{y}_{L}=νφ

\dot{s}=ν

Thus, EQ. 1 can be manipulated as follows to estimate a raw sensor bias term, as follows in EQ. 2:

b=\tilde{ω}(Cν+\dot{ω})+n [2]

A sensor bias learning rule can be generated, permitting regular updating of the sensor bias based upon observed data, as shown with reference to EQ. 3.

b^{(new)}=(1−η)b^{(old)}+ηE{\tilde{ω}−(Cν+\dot{φ})} [3]

wherein:

b^{(old)} denotes a sensor bias estimate from a previous iteration,

b^{(new)} denotes the new bias estimate after new data (\tilde{ω}, C, ν, \dot{φ}) is available,

E{ } denotes the distribution expectation, and

η represents a learning rate, which is a small calibratable positive number.

Referring again to FIG. 2, the bias angle α 116 between the first and second vehicle heading parameters 112, 114 is expressed as (\tilde{ω}−Cν)−\dot{φ}, and is regularly and ongoingly determined to estimate a raw sensor bias term b.

The raw sensor bias term b is calculated based upon the bias angle α 116 between the first and second vehicle heading parameters 112, 114 in accordance with the relationships set forth in EQS. 1 and 2. The raw sensor bias term b is subjected to the sensor bias learning rule of EQ. 3, including, e.g., calculating a moving average over multiple observations of new data (\tilde{ω}, C, ν, \dot{φ}) when it becomes available (130), to determine a final sensor bias term b′ 140. The final sensor bias term b′ 140 is additively combined with the most recently observed yaw rate ( [symbol] 104 to determine an updated yaw raw 150, which can be used for vehicle control, including controlling the ADAS via the autonomous controller 65.

The regular readings of the difference between the first and second vehicle heading parameters 112, 114 may expressed as a bias angle α 116, as follows:

(ω−Cν)−\dot{φ}=α [4]

The bias angle α 116 is input to a distribution estimator (120) for statistical analysis over a series of events. The output of the distribution estimator (120) is a probability estimate that the bias angle α 116 is less than a threshold angle T_{α}, i.e., P(|α|<T_{α}) 122. When the probability estimate that the bias angle α 116 is less than the threshold angle T_{α}, is less than a minimum threshold (122)(0), it indicates an occurrence of a fault with the yaw-rate sensor 45 (124). When the probability estimate that the bias angle α 116 is less than the threshold angle T_{α}, is greater than the minimum threshold (122)(1), it indicates absence of a fault with the yaw-rate sensor 45 (126). This information is conveyed to the vehicle controller to act in accordance therewith, including disabling operation of ADAS features such as lane keeping and lane change assistance maneuvers in the presence of a fault.

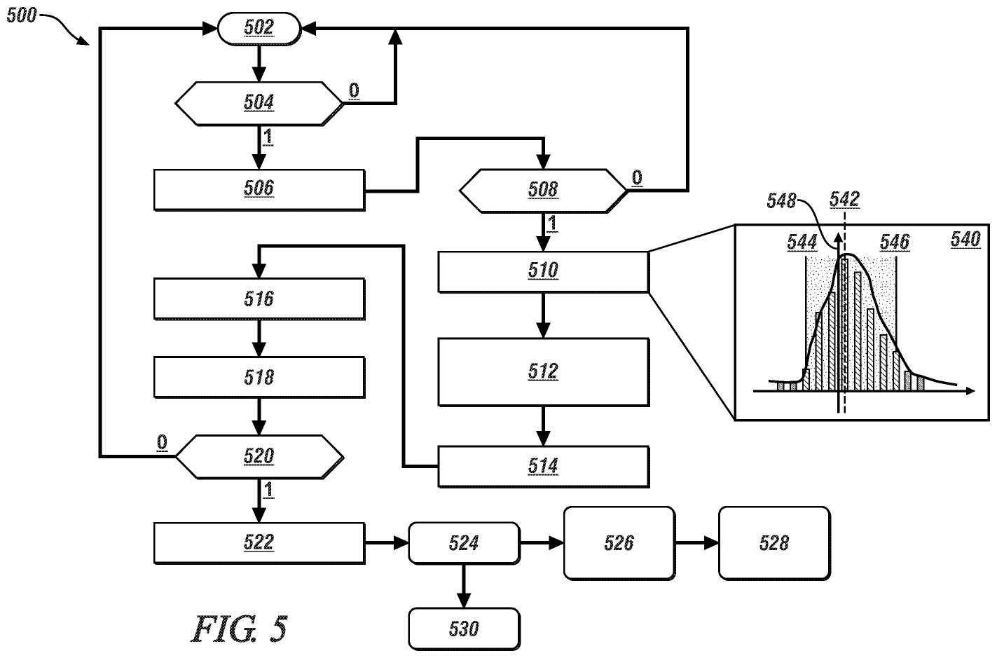

FIG. 5 schematically shows an embodiment of a routine 500 for monitoring an on-vehicle yaw-rate sensor, which is described with reference to the vehicle 10 of FIG. 1, and incorporating the concepts described with reference to FIGS. 2, 3 and 4. Table 1 is provided as a key wherein the numerically labeled blocks and the corresponding functions are set forth as follows, corresponding to the routine 500. The teachings may be described herein in terms of functional and/or logical block components and/or various processing steps. The block components may be composed of hardware, software, and/or firmware components that have been configured to perform the specified functions.

TABLE 1

| BLOCK | BLOCK CONTENTS |
|---|---|
| 502 | Start |
| 504 | New sensor data? |
| 506 | Determine yaw-rate sensor bias angle α |
| | α = (\tilde{ω} − Cν) − \dot{φ} |
| 508 | Sufficient quantity of data? |
| 510 | Sort bias angle α in circular buffer |
| 512 | Select median portion of circular buffer |
| | Determine distribution expectation E{ } |
| 514 | Determine b^{(new)} based upon EQ. 3 |
| 516 | Update histogram, clear circular buffer |
| 518 | Determine probability P(\|α\| < T_{α}) |
| 520 | Is P(\|α\| < T_{α}) > threshold? |
| 522 | Report bias estimate b^{(new)} |
| 524 | Evaluation bias estimate b^{(new)} |
| 526 | Update yaw rate based upon observed yaw |
| | rate and bias estimate b^{(new)} |
| 528 | Control vehicle operation based upon |
| | updated yaw rate |
| 530 | Execute yaw-rate sensor fault detection |

Execution of the routine 500 may proceed as follows. The steps of the routine 500 may be executed in a suitable order, and are not limited to the order described with reference to FIG. 5. As employed herein, the term “1” indicates an answer in the affirmative, or “YES”, and the term “0” indicates an answer in the negative, or “NO”.

The concepts described herein include starting execution by looking for newly acquired data observations (\tilde{ω}, C, ν, \dot{φ}) (502). When acquired (504)(1), the yaw-rate sensor bias angle α is determined in accordance with α=(\tilde{ω}−Cν)−\dot{φ}, and saved to a circular memory buffer (506). When a sufficient quantity of observations of the yaw-rate sensor bias angle α is determined, e.g., when the memory of the circular buffer is full (508)(1), the observations in the circular buffer are sorted (510). Sorting of the observations in the circular buffer may also include evaluating and removing data outliers. An example representation of sorting the observations in the circular buffer may be illustrated as a histogram 540. The histogram 540 includes quantity of observations in the vertical axis, in relation to the yaw-rate sensor bias angle α, which are shown on the horizontal axis. A mean value 542 for the yaw-rate sensor bias angle α and allowable error bars 544, 546 representing +/−one standard deviation, respectively, are indicated. Also shown is Aw 548, which represents an absolute bias angle.

A data subset representing the median portion of the circular buffer is selected, and employed to calculate a mean value for E{\tilde{ω}−(Cν+\dot{φ}) (512), and the bias learning rule associated with EQ. 3 is executed to determine the new bias angle estimate b^{(new)} (514). The global histogram is recursively updated employing the selected median portion of the circular buffer (516), and employed to determine the probability that the absolute value for the yaw-rate sensor bias angle α is less than a threshold angle T_{α}, i.e., P(|α|<T_{α}) (518). When the probability that the absolute value for the yaw-rate sensor bias angle α is not less than the threshold angle T_{α} (520)(0), the routine restarts (502).

When the probability that the absolute value for the yaw-rate sensor bias angle α is less than the threshold angle T_{α} (520)(1), the new bias angle estimate b^{(new)} is reported out (522), and subjected to an evaluation step (524). An updated yaw rate can be determined based upon the observed yaw rate and the new bias angle estimate b^{(new)} (526), and operation of the vehicle 10, including ADAS, may be controlled based thereon (528). The evaluation step (524) may also indicate a fault in the sensor (530), which may require remedial action, such as disabling operation of the ADAS system or other on-vehicle systems that employ the yaw-rate sensor 45.

The concepts described herein provide a method and associated system that provides continuous learning of a sensor bias and correction without a need for restricting driving conditions. The concepts also employ independent sources for determining the sensor bias, resulting in a sensor bias determination that is robust to temperature-related drifts.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method for monitoring an on-vehicle yaw-rate sensor, the method comprising:
determining a vehicle heading during vehicle operation;
determining a first vehicle heading parameter based upon the vehicle heading;
determining, via the yaw-rate sensor, a second vehicle heading parameter;
determining a yaw-rate sensor bias parameter based upon the first vehicle heading parameter and the second vehicle heading parameter;
determining, via the yaw-rate sensor, a first yaw term; and
determining a final yaw term based upon the first yaw term and the yaw-rate sensor bias parameter.

2. The method of claim 1, wherein determining the vehicle heading comprises monitoring input from a global navigation satellite system (GNSS) sensor to determine the vehicle heading.

3. The method of claim 1, wherein determining the vehicle heading comprises:
determining, via a GNSS sensor, a map heading parameter;
determining, via a camera, a camera heading parameter;
determining, via a third sensor, a third heading parameter;
determining respective first, second, and third weighting factors for the map heading parameter, camera heading parameter, and third heading parameter, respectively; and
determining the first vehicle heading parameter based upon the map heading parameter, the camera heading parameter, the third heading parameter, and the respective first, second, and third weighting factors.

4. The method of claim 3, wherein the third sensor includes a surround-view camera, wherein determining, via the third sensor, the third heading parameter comprises determining the third heading parameter based upon the surround-view camera, and wherein determining the first vehicle heading parameter comprises determining the first vehicle heading parameter based upon the map heading parameter, the camera heading parameter, and the third heading parameter.

5. The method of claim 3, wherein the third sensor includes a lidar device, wherein determining, via the third sensor, the third heading parameter comprises determining the third heading parameter based upon the lidar device, and wherein determining the first vehicle heading parameter comprises determining the first vehicle heading parameter based upon the map heading parameter, the camera heading parameter, and the third heading parameter.

6. The method of claim 3, wherein the first, second, and third weighting factors for the map heading parameter, the camera heading parameter, and the third heading parameter, respectively, are dynamically determined based upon expected reliabilities of the map heading parameter from the GNSS sensor, the camera heading parameter from the camera, and the third heading parameter from the third sensor.

7. The method of claim 1, further comprising detecting a fault associated with the yaw-rate sensor when the yaw-rate sensor bias parameter is greater than a threshold.

8. The method of claim 1, further comprising controlling operation of the vehicle based upon the final yaw term.

9. The method of claim 1, wherein determining the first vehicle heading parameter based upon the vehicle heading comprises determining a first vehicle heading change rate based upon the first vehicle heading parameter.

10. The method of claim 1, wherein determining, via the yaw-rate sensor, the second vehicle heading parameter comprises determining a second vehicle heading change rate based upon the second vehicle heading parameter.

11. The method of claim 1, further comprising:
periodically determining the first vehicle heading parameter and the second vehicle heading parameter; and
periodically determining a bias parameter based upon the periodically determined first vehicle heading parameter and second vehicle heading parameter;
wherein determining the yaw-rate sensor bias parameter based upon the first vehicle heading parameter and the second vehicle heading parameter comprises determining a mean value for the periodically determined bias parameter.

12. The method of claim 1, wherein determining the vehicle heading during vehicle operation comprises determining the vehicle heading during dynamic vehicle operation that includes operation on a curved roadway.

13. A vehicle, comprising:
a yaw-rate sensor;
a second sensor arranged to monitor a vehicle heading; and
a controller, in communication with the yaw-rate sensor and the second sensor, the controller including a memory device including an instruction set, the instruction set executable to:
determine, via the second sensor, a vehicle heading during vehicle operation,
determine a first vehicle heading parameter based upon the vehicle heading,
determine, via the yaw-rate sensor, a second vehicle heading parameter,
determine a yaw-rate sensor bias parameter based upon the first vehicle heading parameter and the second vehicle heading parameter,
determine, via the yaw-rate sensor, a first yaw term,
determine a final yaw term based upon the first yaw term and the yaw-rate sensor bias parameter, and
control operation of the vehicle based upon the final yaw term.

14. The vehicle of claim 13, wherein the second sensor arranged to monitor the vehicle heading comprises a global navigation satellite system (GNSS) sensor.

15. The vehicle of claim 13, wherein the second sensor arranged to monitor the vehicle heading comprises a plurality of sensors including a GNSS sensor, a camera, and a third sensor; and wherein the instruction set executable to determine, via the second sensor, a vehicle heading during vehicle operation, comprises the instruction set executable to:
determine, via the GNSS sensor, a map heading parameter,
determine, via a camera, a camera heading parameter,
determine, via a third sensor, a third heading parameter,
determine respective first, second, and third weighting factors for the map heading parameter, the camera heading parameter, and the third heading parameter, respectively, and
determine the first vehicle heading parameter based upon the map heading parameter, the camera heading parameter, the third heading parameter, and the respective first, second, and third weighting factors.

16. The vehicle of claim 15, wherein the third sensor includes a surround-view camera, wherein the instruction set is executable to determine the third heading parameter based upon the surround-view camera, and wherein the instruction set is executable to determine the first vehicle heading parameter based upon the map heading parameter, the camera heading parameter, and the third heading parameter.

17. The vehicle of claim 15, wherein the third sensor includes a lidar device, wherein the instruction set is executable to determine the third heading parameter based upon the lidar device, and wherein the instruction set is executable to determine the first vehicle heading parameter based upon the map heading parameter, the camera heading parameter, and the third heading parameter.

18. The vehicle of claim 13, further comprising the instruction set executable to detect a fault associated with the yaw-rate sensor when the yaw-rate sensor bias parameter is greater than a threshold.

19. The vehicle of claim 13, further comprising the instruction set executable to control operation of the vehicle based upon the final yaw term.
